(19) United States
(12) Patent Application Publication
(10) Pub. No.: US 2015/0161705 A1
(43) Pub. Date: Jun. 11, 2015

(54) MERCHANT RECOMMENDATION ENGINE METHOD AND APPARATUS

(71) Applicant: MASTERCARD INTERNATIONAL INCORPORATED, Purchase, NY (US)

(72) Inventors: Rohit Chauhan, Somers, NY (US); Po Hu, Norwalk, CT (US); Jean-Pierre Gerard, Croton-On-Hudson, NY (US); Tong Zhang, Greenwich, CT (US)

(73) Assignee: MASTERCARD INTERNATIONAL INCORPORATED, Purchase, NY (US)

(21) Appl. No.: 14/038,650

(22) Filed: Dec. 9, 2013

(51) Int. Cl. G06Q 30/06; G06Q 40/00

(52) U.S. Cl. CPC G06Q 30/0631; G06Q 40/00

(57) ABSTRACT

A system, method, and computer-readable storage medium configured to enable vendor recommendations using payment card transaction information.

### BACKGROUND

1. Field of the Disclosure

Aspects of the disclosure relate in general to financial services and computer science. Aspects include an apparatus, system, method and computer-readable storage medium to enable a merchant recommendation engine using payment card transaction information. Another aspect includes a computational method to reduce the size of memory space and amount of processor time to enable a merchant recommendation engine.

2. Description of the Related Art

In an increasingly mobile society, consumers are on the go, traveling to unfamiliar destinations. Even when in a familiar locale, consumers often want to try new places, restaurants, merchants or other vendors.

Typically, when trying new places, consumers get recommendations from sources with similar tastes—be it newspaper or periodical reviews, suggestions from friends, and increasingly, the Internet.

The problems of such recommendation sources are many. They are typically not comprehensive, and are often small in scope. They are not always up-to-date.

At the same time, the use of payment cards, such as credit, debit, or prepaid cards, is now ubiquitous in commerce. Typically, a payment card is electronically linked via a payment network to an account or accounts belonging to a cardholder. These accounts are generally deposit accounts, loan or credit accounts at an issuer financial institution. During a purchase transaction, the cardholder can present the payment card in lieu of cash or other forms of payment.

Payment networks process trillions of purchase transactions by cardholders.

### SUMMARY

Embodiments include a system, device, method and computer-readable medium configured to enable vendor recommendations using payment card transaction information.

In a recommendation method embodiment, financial transaction entries are extracted from a database stored on a computer-readable storage medium. A processor filters the financial transaction entries based on an application domain to produce domain-filtered financial transaction entries. The domain-filtered financial transaction entries are filtered based on a geographic location of each domain-filtered financial transaction entry to produce geographically-filtered financial transaction entries. The processor pairwise computes similarities between geographically-filtered financial transaction entries from multiple cardholders to produce recommendations. The recommendations are stored in the database.

A recommendation apparatus comprises a computer readable storage medium and a processor. The computer-readable storage medium is configured to store financial transaction entries in a database. The processor is configured to extract the financial transaction entries from the database, to filter the financial transaction entries based on an application domain to produce domain-filtered financial transaction entries, to filter the domain-filtered financial transaction entries based on a geographic location of each domain-filtered financial transaction entry to produce geographically-filtered financial transaction entries, and to pairwise compute similarities between geographically-filtered financial transaction entries from multiple cardholders to produce recommendations. The computer-readable storage medium is further configured to store the recommendations in the database.

A non-transitory computer readable medium embodiment is encoded with data and instructions. When executed by a computing device, the instructions cause the computing device to perform a recommendation method. Financial transaction entries are extracted from a database stored on a computer-readable storage medium. A processor filters the financial transaction entries based on an application domain to produce domain-filtered financial transaction entries. The domain-filtered financial transaction entries are filtered based on a geographic location of each domain-filtered financial transaction entry to produce geographically-filtered financial transaction entries. The processor pairwise computes similarities between geographically-filtered financial transaction entries from multiple cardholders to produce recommendations. The recommendations are stored in the database.

### BRIEF DESCRIPTION OF THE DRAWINGS

FIG. 1 illustrates an embodiment of a recommendation system configured to enable vendor recommendations using payment card transaction information.

FIG. 2 depicts a block diagram of a payment network configured to enable vendor recommendations using payment card transaction information using payment card transaction information.

FIG. 3 flowcharts a method embodiment to enable vendor recommendations using payment card transaction information using payment card transaction information.

### DETAILED DESCRIPTION

One aspect of the disclosure includes the realization that customers will have similar preferences to cardholders with similar payment patterns. As a consequence, by analyzing a first cardholder's payment patterns and comparing it to similar payment patterns from other cardholders, an automated system can recommend vendors to the first cardholder based on other cardholder's payment transactions.

Another aspect of the disclosure includes the understanding that with millions of potential vendor locations, and trillions of cardholder transactions, a recommendation engine requires a huge memory space and significant computational resources. For example, for a half-million restaurants in the United States, a conventional comparison approach will take a half-year on a typical computer. As a result, a further aspect of the disclosure is the realization that a conventional comparison approach cannot be used.

Embodiments of the present disclosure include a system, method, and computer-readable storage medium configured to enable vendor recommendations using payment card transaction information.

For the purposes of this disclosure, a payment card transaction includes, but is not limited to, purchases made with credit cards, debit cards, prepaid cards, electronic checking, electronic wallet, or mobile device payments.

It is further understood by those familiar with the art that cardholders and employers may be required to opt-in, opt-out, or enroll for the recommendation features and benefits described herein to comply with legal or regulatory authorities. It is further understood that the opt-in, opt-out, or enrollment may include enrollments based on cardholder affiliation, cardholder status, transaction analysis, and geographic location information provided to a payment network.

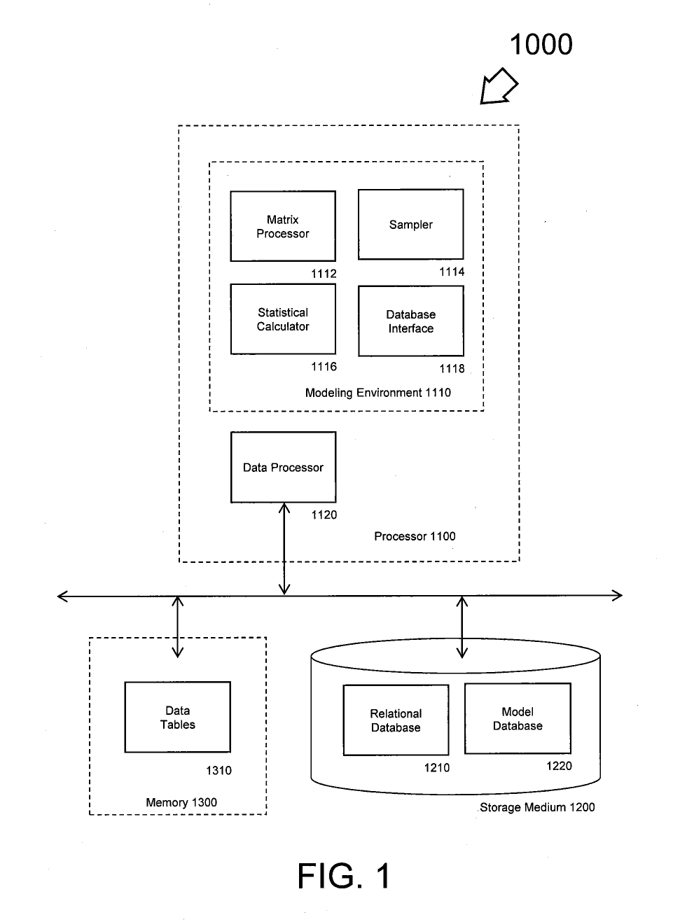

FIG. 1 illustrates an embodiment of a system 1000 configured to enable vendor recommendations using payment card transaction information, constructed and operative in accordance with an embodiment of the present disclosure.

System 1000 includes a cardholder using a payment card 1000a, mobile device 1100b, electronic wallet 1100c or other electronic devices 1100d issued by an issuer 1500a-n for use at a vendor 1600. It is understood that a financial transaction at the vendor 1600 may occur in person at a “brick-and-mortar”location, or via a mobile communications network 1300 or the Internet 1200. Whenever a financial transaction occurs at a vendor 1600 using a payment card 1100, the vendor 1600 communicates with an acquirer financial institution 1650 and payment network 2000 via interbank network 1400 to determine the financial worthiness of the cardholder. Additionally, payment network 2000 may connect in turn to issuer bank 1500. Details and example methods of payment network 2000 are discussed below.

The vendor 1600 may be a store, restaurant, travel provider, merchant, or other service provider that offers goods or services to cardholders.

An issuer financial institution 1500 is the institution that provides the credit for the financial payment transaction. Issuer 1500 processes data (authorization requests) via the payment network 2000 and prepares the authorization-formatted response (approvals/declines).

Payment network 2000 is a payment network capable of processing payments electronically. An example payment network 2000 includes the network operated by MasterCard International Incorporated. Payment network 2000 includes the set of application program interface (API) functions, processes, and data that allow a financial transaction to take place. Additionally, payment network 2000 may analyze cardholder spending patterns to recommend vendors to a customer. In some embodiments, the recommendations may be made available to cardholders via the World Wide Web, or dedicated application (“app”) running on a cardholder mobile device 1100b.

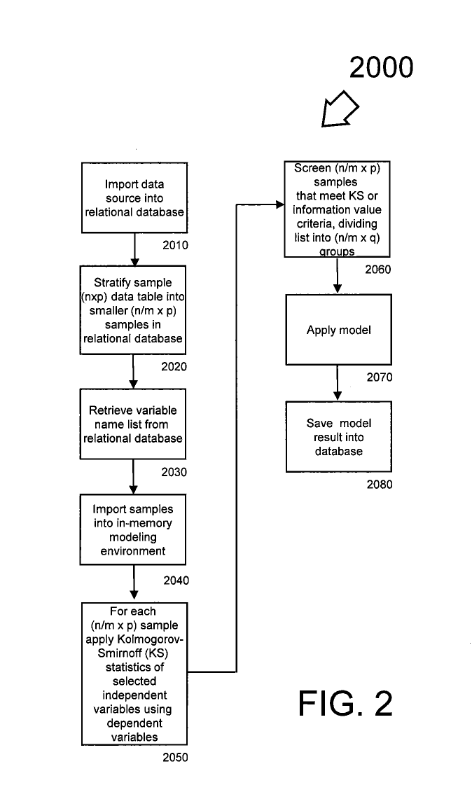

Embodiments will now be disclosed with reference to a block diagram of an exemplary payment network server 2000 of FIG. 2, constructed and operative in accordance with an embodiment of the present disclosure.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may communicate with and temporarily store information in Random Access Memory (RAM) (not shown).

As shown in FIG. 2, processor 2100 is functionally comprised of a recommendation engine 2110, a payment-purchase engine 2130, and a data processor 2120.

Recommendation engine 2110 may further comprise: a database API 2112, pairwise computer 2114, recommendation report generator 2116, and recommendation portal 2118.

Database API 2112 acts as an interface between recommendation engine 2110 and various databases.

Pairwise computer 2114 is the portion of the recommendation engine 2110 that is configured to calculate pairwise similarity of payment transactions. Pairwise computer 2114 enables payment network 2000 to analyze cardholder spending and determine similar spending patterns by other cardholders.

Recommendation report generator 2116 produces recommendation reports for the recommendation engine 2110.

Recommendation portal 2118 is the application interface that allows cardholders to receive recommendations from recommendation engine. In some embodiments, recommendation portal 2118 is a World Wide Web (WWW or “web”) site that is enabled to communicate recommendations for classes of cardholders. In other embodiments, recommendation portal 2118 may facilitate communication with an application on a cardholder's mobile device or mobile phone. It is understood by those familiar with the art that recommendation portal 2118 may be located in a different physical or virtual location from payment network 2000, such as issuer 1500 or another web-site. However, the purposes of this disclosure, it is assumed that the recommendation portal 2118 is located at payment network 2000.

Payment-purchase engine 2130 performs payment and purchase transactions, and may do so in conjunction with the embodiments described herein.

Data processor 2120 enables processor 2100 to interface with storage medium 2200, network interface 2300 or any other component not on the processor 2100. The data processor 2120 enables processor 2100 to locate data on, read data from, and write data to these components.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with vendors 1600, cardholder devices 1100, and/or issuer 1500.

Computer-readable storage medium 2200 may be a conventional read/write memory, such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a transaction database 2210, geographic location (address) database 2220, location web-link (map) database 2230 and a recommendation database 2240. Transaction database 2210 is configured to store the details of financial transactions. Geographic location (address) database 2220 stores the physical address information of vendors 1600. Location web-link (map) database 2230 facilitates the look-up of mapping information for physical addresses provided by geographic location (address) database 2220. Recommendation database 2240 is configured to store vendor recommendations for cardholders.

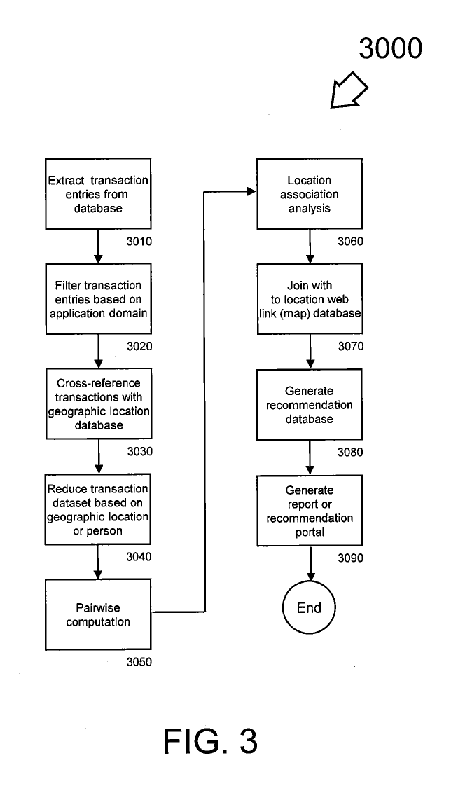

It is understood by those familiar with the art that one or more of these databases 2210-2240 may be combined in a myriad of combinations. The function of these structures may best be understood with respect to the flowchart of FIG. 3, as described below.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 flowcharts a payment network method 3000 embodiment to enable vendor recommendations using payment card transaction information, constructed and operative in accordance with an embodiment of the present disclosure. In such an embodiment, a recommendation engine 2110 takes a universe or subset of a payment network's financial transactions to determine recommendations for a cardholder based on the cardholder's spending pattern. This may be accomplished through matching the cardholder's transactions and comparing it to that of similar spending patterns by other cardholders. However, this is a monumental task as the universe of vendors 1600 and financial transactions is very large, which results in a great deal of computer resources and memory being used. Embodiments of the present disclosure reduce the amount of computing resources and memory required through intelligent reduction of the transaction and vendor dataset.

Initially database API 2112 extracts transaction records from a transaction database 2210, block 3010. Typically, transaction database 2210 may be populated with a record of cardholder financial transactions by a payment network 2000 or issuer 1500.

Recommendation engine 2110 reduces the transaction data set by comparison on an application domain, block 3020. In this context, the application domain is the type of the recommendation that the cardholder is seeking. For example, if the cardholder is looking for restaurant recommendations, all non-food-related transactions are filtered out. Similarly, if a cardholder is looking for a recommended golf course, non-golf-related transactions are filtered.

Once the transaction data set has been filtered on application domain, it can be further filtered on geographic location. Each transaction within the transaction data set is cross-referenced with the geographic location database 2220 to determine the physical address and geographic location where each transaction occurred, block 3030. In some embodiments, the geographic location may be identified as a particular geographic coordinate, street, neighborhood, borough, city, county, parish, state, country, or postal code. For example, a restaurant purchase transaction could be identified as having occurred within New York City (city), Manhattan (borough), Union Square (neighborhood), East 14th Street (street), or at zip code 10003 (postal code).

At block 3040, recommendation engine 2110 reduces the data set based on the geographic parameters of the recommendation as defined by the cardholder. The cardholder may request a recommendation based on the radius of a particular geographic coordinate, street, neighborhood, borough, city, county, parish, state, country, or postal code. For example, if the cardholder is looking for restaurant advice in the Union Square neighborhood of New York City, depending upon the embodiment, the filtering may remove transactions that took place outside of Union Square or outside of a certain radius of Union Square. In another example, the cardholder may simply ask for restaurant advice within five miles of their current or otherwise specified position.

At block 3050, the resulting geographically filtered data is sent to the pairwise computer 2114 to determine matching piecewise (local) or global alignments of both the cardholder spending against other cardholder spending. In its calculation, the pairwise computer 2114 may use pairwise alignments such as dot-matrix methods, dynamic programming, and/or word methods known in the art.

The recommendation portal 2110 performs a location association analysis at block 3060, and each recommendation is joined with location (mapping) information from a location-web-link database 2230 that provides mapping information for the recommendation, block 3070.

The resulting information is processed to generate a recommendation database 2240, at block 3080, to generate a report or recommendation portal, block 3090.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A recommendation method comprising:
extracting financial transaction entries from a database stored on a computer-readable storage medium;
filtering, with a processor, the financial transaction entries based on an application domain to produce domain-filtered financial transaction entries;
filtering, with the processor, the domain-filtered financial transaction entries based on a geographic location of each domain-filtered financial transaction entry to produce geographically-filtered financial transaction entries;
computing, with the processor, similarities between geographically-filtered financial transaction entries from multiple cardholders to produce recommendations;
storing the recommendations in the database.

2. The method of claim 1 further comprising:
generating a report, via the processor, based on the recommendations.

3. The method of claim 2 further comprising:
electronically transmitting the report, via a network interface, to a cardholder.

4. The method of claim 3 wherein the report is electronically transmitted to a cardholder mobile device.

5. The method of claim 3 wherein the report is electronically transmitted via the World Wide Web.

6. The method of claim 3 wherein the application domain is merchants, restaurants, or service provider.

7. The method of claim 3 wherein the geographic location is a geographic coordinate, street, neighborhood, borough, city, county, parish, state, country, or postal code.

8. A recommendation apparatus comprising:
a computer-readable storage medium configured to store financial transaction entries in a database;
a processor configured to extract the financial transaction entries from the database, to filter the financial transaction entries based on an application domain to produce domain-filtered financial transaction entries, to filter the domain-filtered financial transaction entries based on a geographic location of each domain-filtered financial transaction entry to produce geographically-filtered financial transaction entries, and to compute similarities between geographically-filtered financial transaction entries from multiple cardholders to produce recommendations;
wherein the computer-readable storage medium is further configured to store the recommendations in the database.

9. The apparatus of claim 8 further comprising:
generating a report, via the processor, based on the recommendations.

10. The apparatus of claim 9 further comprising:
electronically transmitting the report, via a network interface, to a cardholder.

11. The apparatus of claim 10 wherein the report is electronically transmitted to a cardholder mobile device.

12. The apparatus of claim 10 wherein the report is electronically transmitted via the World Wide Web.

13. The apparatus of claim 10 wherein the application domain is merchants, restaurants, or service provider.

14. The apparatus of claim 10 wherein the geographic location is a geographic coordinate, street, neighborhood, borough, city, county, parish, state, country, or postal code.

15. A non-transitory computer readable medium encoded with data and instructions, when executed by a computing device the instructions causing the computing device to:
extract financial transaction entries from a database stored on a computer-readable storage medium;
filter, with a processor, the financial transaction entries based on an application domain to produce domain-filtered financial transaction entries;
filter, with the processor, the domain-filtered financial transaction entries based on a geographic location of each domain-filtered financial transaction entry to produce geographically-filtered financial transaction entries;
compute, with the processor, similarities between geographically-filtered financial transaction entries from multiple cardholders to produce recommendations; and
store the recommendations in the database.

16. The non-transitory computer readable medium of claim 15 further comprising instructions to:
generate a report, via the processor, based on the recommendations.

17. The non-transitory computer readable medium of claim 16 further comprising instructions to:
electronically transmit the report, via a network interface, to a cardholder.

18. The non-transitory computer readable medium of claim 17 wherein the report is electronically transmitted to a cardholder mobile device.

19. The non-transitory computer readable medium of claim 17 wherein the report is electronically transmitted via the World Wide Web.

20. The non-transitory computer readable medium of claim 17 wherein the application domain is merchants, restaurants, or service provider.
